(19) United States
(12) Patent Application Publication
(10) Pub. No.: US 2011/0309022 A1
(43) Pub. Date: Dec. 22, 2011

(54) OIL RECOVERY SYSTEM AND METHOD

(75) Inventors: David L. BRIGGS, Evansville, IN (US); Kenneth Allen FLATT, JR., Birmingham, AL (US)

(73) Assignee: MOBILE FLUID RECOVERY, INC., Birmingham, AL (US)

(21) Appl. No.: 12/817,138

(22) Filed: Jun. 16, 2010

(51) Int. Cl. C02F 1/40; E02B 15/04; B01D 17/038; C02F 1/28

(52) U.S. Cl. 210/663; 210/257.1; 210/188; 210/241

(57) ABSTRACT

A system and method for recovering oil/water compositions from waterways and wetlands and for separating oil and water from one another. The system includes a plurality of polymeric sorbent articles for collection of oil/water compositions from waterways or wetlands. A centrifuge treatment system having a centrifuge housing, a cover and a rotatable basket is configured for receiving the plurality polymer sorbent articles containing oil/water compositions for removal of oil/water compositions therefrom. Fluids extracted from the sorbent materials are collected in a collection tank in flow communication with an annular area of the centrifuge. A centrifugal oil/water separation unit is provided for essentially continuous separation of oil and water from one another with an efficiency of at least 97%. The system optionally includes a polishing unit for treatment of the water to provide substantially hydrocarbon free water.

### TECHNICAL FIELD

The disclosure relates generally to methods and apparatus for recovery of oil from oil/water mixtures or emulsions from waterways and wetlands, and in particular to on-site cleaning of oil spills and leaks and recovery and separation of oil and water from one another.

### BACKGROUND AND SUMMARY

With regard to environmental protection and rehabilitation of waterways and wetlands, there does not exist mobile technology that is capable of collecting and recovering oil from a mixture or emulsion of oil and water and the substantially continuous separation of oil and water from one another. The environmental problem of oil spills and leaks is particularly troublesome when the oil/water mixture or emulsion covers vast areas of the waterways or wetlands. Collection and transportation of the oil/water mixture or emulsion to fixed treatment facilities prohibitively expensive because of the volume of liquid that must be transported to the facilities. What is needed is portable system that is capable of effectively collecting vast quantities of oil/water mixtures or emulsions on site and the essentially continuous separation of water and oil from one another without the need to store vast quantities of the oil/water mixture or emulsion or the transportation of large quantities to off-site treatment facilities.

With regard to the foregoing and other and advantages, the disclosure provides an integrated system for the collection of oil/water compositions and for the separation of water and oil from one another. The system includes a plurality of polymeric sorbent articles for collection of oil/water compositions from waterways or wetlands. A centrifuge treatment system including a centrifuge having a housing, a housing cover and a rotatable basket received within an interior portion of the centrifuge defined by the housing and cover, is provided. The rotatable basket of the centrifuge is configured for receiving the plurality polymer sorbent articles containing oil/water compositions for removal of oil/water compositions therefrom by rotation of the basket at a speed sufficient to apply extractive forces to the sorbent articles so that fluids extracted from the sorbent articles travel from the basket into an annular area between the basket and the housing. Fluids extracted from the sorbent materials are collected in a collection tank in flow communication with the annular area of the centrifuge. A centrifugal oil/water separation unit having a oil/water composition inlet, an oil outlet and a water outlet is provide. The inlet of the separation unit is in in flow communication with the collection tank for essentially continuous separation of water and oil from one another with an efficiency of at least 97%. The system optionally includes a polishing unit in flow communication with the water outlet for treatment of the water to provide substantially hydrocarbon free water.

In another aspect the disclosure provides a method a method for recovering oil from an oil spill or leak into waterways or wetlands. The method includes disposing a plurality of polymeric sorbent articles for collection of oil/water compositions from the waterways or wetlands. The sorbent articles are centrifuged in a centrifuge treatment system that includes a centrifuge having a housing, a housing cover and a rotatable basket received within an interior portion of the centrifuge defined by the housing and cover. The rotatable basket is configured for receiving the plurality polymer sorbent articles containing the oil/water composition and for removal of the oil/water composition therefrom by rotation of the basket at a speed sufficient to apply extractive forces to the sorbent articles so that fluids extracted from the sorbent articles travel from the basket into an annular area between the basket and the housing. Fluids extracted from the sorbent articles are collected in a collection tank in flow communication with the annular area of the centrifuge. Fluids flow from the collection tank into a centrifugal oil/water separation unit having a fluid inlet, an oil outlet and a water outlet, the inlet being in flow communication with the collection tank for essentially continuously separating water and oil from one another with an efficiency of at least 97%. A polishing unit is optionally provided in flow communication with the water outlet of the centrifugal oil/water separator for treatment of the water to provide substantially hydrocarbon free water.

An important aspect of the invention is integration of the removal of oil/water compositions from a variety of solid sorbent materials and the treatment of the fluids from the sorbent materials in an integrated system. The system includes components that enable the system to be mounted on a vehicle for movement to remote locations for on-site recovery of organic fluids and for reconditioning of sorbent materials in an efficient and effective manner. Since the system is capable of removing 97% or more of oil and hydrocarbons from water on site, the system reduces the need to transport relatively large volumes of fluids or relatively large numbers of drums or other receptacles filled with sorbent materials containing organic fluids which may be classified as hazardous to a remote location for treatment or reconditioning

### BRIEF DESCRIPTION OF THE DRAWINGS

The above and other features and advantages of the disclosed embodiments may become further known from the following detailed description considered in conjunction with the accompanying drawings in which:

FIG. 1 is a somewhat schematic drawing of a system for treating sorbent materials to remove a oil/water composition therefrom and for separating oil and water from one another;

FIG. 2 is a schematic representation of various sorbent articles that may be used with the system according to the invention;

FIG. 3 is a detailed cross-sectional view of a centrifuge for use with the system; and

FIG. 4 is detailed view of a water/oil separation unit.

### DETAILED DESCRIPTION

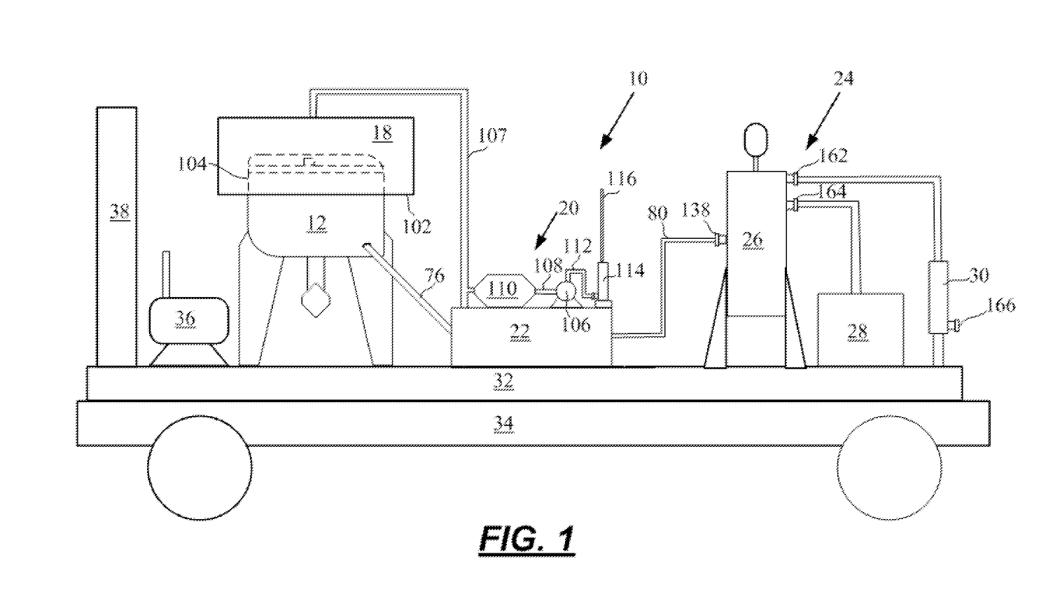

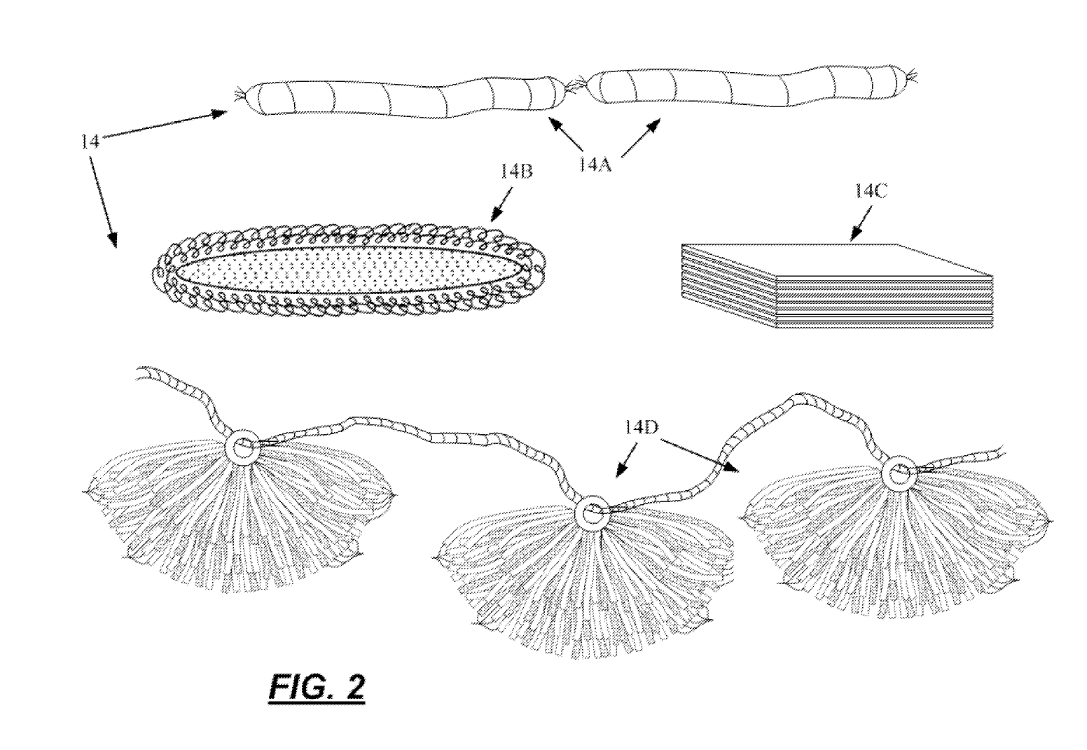

With initial reference to FIGS. 1-2, there is shown a system 10 for recovering organic fluids such as oil and separating oil and water from one another in accordance with embodiments of the disclosure. The system 10 includes a centrifuge apparatus 12 for removing fluids sorbent articles 14 including sorbent booms 14A, sorbent pads 14B, sorbent sheet 14C, and sorbent pom-poms 14D (FIG. 2) that may be loaded into the centrifuge apparatus 12. Each of the sorbent articles 14 may be disposed on water or wetlands to collect oil from the water or wetlands. In the case of the sorbent booms 14A and sorbent pom-poms 14D, each of the booms and pom-poms may be connected together in a chain configuration with clips to collect the oil. The booms 14A and pom-poms 14D may be collected, disconnected from one another, put in the centrifuge apparatus 12, spun to remove oil and water therefrom, then reconnected to one another and put back in the water. Likewise, each of the sorbent articles 14 may be disposed on the waterways or wetlands, collected, and put into the centrifuge apparatus 12 for removing oil and water therefrom, then redeployed on the waterways or in the wetlands. Accordingly, the sorbent articles 14 are desirably made of materials that enable the articles 14 to float on the water to collect the oil.

In an alternative embodiment, sorbent articles 14 may be put into a land fill, or may be recycled. Accordingly, sorbent articles 14 made of polymeric materials may be ground, melted, recrystallized, and/or densified and may be fed into an extruder with or without virgin materials to provide a recycled thermoplastic material that may be used to mold thermoplastic parts.

The centrifuge apparatus 12 optionally includes a hood 18 that is associated with a fume collection system 20 for collection and treatment of fumes that may be associated with the fluids in the sorbent articles 14. A collection tank 22 is provided for collection of fluids removed from the pads and for feeding the fluids to an oil/water separation unit 24.

The oil/water separation unit 24 includes a centrifugal separator 26 that provides for essentially continuous separation of oil and water from one another. Oil flowing from the centrifugal separator 26 may be collected in oil collection tank 28, while the water flows through a polishing unit 30 and the water discharging from the polishing unit 30 may be collected or discharged back into the waterways or wetlands.

The entire system 10 is configured on a base 32 that may be mounted on a vehicle 34 for transport to remote locations. A power unit or generator 36 may be included with the system 10 for providing power for operating components on the system 10. A control panel 38 may be provided for manual, automatic, or semi-automatic operation of the system 10 and for relaying operating conditions to a location remote from the system 10. In the alternative, a power converter may be provided to supply power from a vehicle to the components of the system 10. The vehicle 34 may be a flat bed truck, a trailer, a boat, a barge, or other suitable forms of transporting the system 10 to the remote location for collecting and treatment of the sorbent articles 14. As will be appreciated, the generator 36 and other motors and electrical equipment in the system 10 may be constructed so as to avoid sparks and the like due to the flammable nature of the fluid collected from the sorbent articles 14.

The sorbent articles 14 may be loaded by hand into the centrifuge 12 or in the alternative, mechanical devices such as fork lifts, lift gates, jib cranes, and the like may be used to lift the sorbent articles 14 into the centrifuge 12. A conveyor system may also be used to move the sorbent articles 14 into and out of the centrifuge 12. If the sorbent articles 14 are collected in drums, a drum dumper may be used to dump the sorbent articles into the centrifuge 12.

As used herein, the term “oil” refers to and includes oleaginous hydrocarbon fluids, and primarily liquid-phase hydrocarbons composition such as crude oil, oil/water emulsions, tar balls, refined oils, fuels, petroleum products, and the like.

The term “substantially oil-free water” and “substantially hydrocarbon-free water” means that the water contains less than 1 wt. % oil and typically less than 0.5 wt. % of oil or hydrocarbons. The term “substantially water-free oil” means that the oil contains less than 5 wt %, typically less than 2 wt. % water.

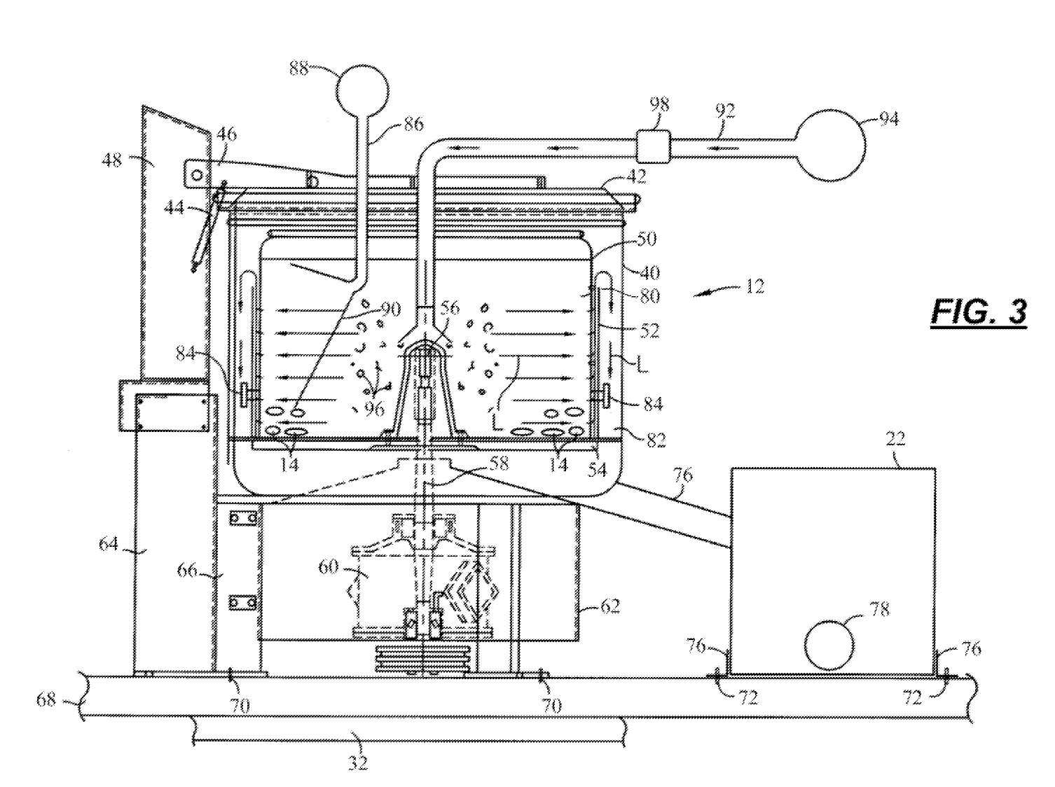

With reference to FIG. 3, a more detailed description of the centrifuge 12 is provided. The centrifuge includes a bowl-shaped housing 40 having a having a movable cover or lid 42 provided to seal an opening in the housing 40 and to cover a basket 50 during operation of the centrifuge 12 so that fluids removed from the sorbent articles 14 remain in the centrifuge 12. The lid 42 may be hinged and selectively openable as by gas springs 44 which extend between support arms 46 and a support column 48 to which the arms 46 are pivotally mounted.

Contained within the housing 40 is a foraminous basket 50 rotatably mounted within a solid outer wall 52 and a solid bottom wall 54. Depending on the quantity and size of sorbent articles 14 to be treated in the system 10, the basket 50 may have a diameter ranging from about 20 inches to about 48 inches, and a depth ranging from about 10 inches to about 20 inches.

The basket 50 may be mounted on a hexagonal ball and socket joint 56 at an upper end of a drive shaft 58. The drive shaft 58 is associated with a drive unit 60 for spinning the shaft 58 and thus the basket 50 to apply centrifugal forces to sorbent articles 14 loaded into the basket 50. A protective metal housing 62 may be provided around the drive unit 60. The basket 50 is caused to spin within a bowl-shaped housing 50 by the drive unit 60 and shaft 58.

During operation of the centrifuge 12, the centrifuge 12 is effective to separate fluids from the sorbent articles 14, primarily oily liquids by use of rotational speeds ranging from about 500 to about 2,500 rpm. A particularly useful rotational speed range from about 1500 to about 2,200 rpm and may provide a G-force of up to about 2060 G's. The centrifuge 12 may be electrically operated or operated using a hydraulic motor, air motor, or internal combustion engine. Due to the corrosive nature of the fluids, the fluid contact surfaces of the centrifuge 12 are suitably made from stainless steel or other corrosion resistant metal. All of the electrical components of the centrifuge 12 are housed in explosion proof housing units. Due to variability in weight distribution of the sorbent articles 14 within the centrifuge 12, the centrifuge may be a self-balancing centrifuge.

As mentioned above, the foraminous basket 50 is mounted within and surrounded by the solid outer wall 52. The outer wall 52 may be sealed against fluid flow by the solid bottom wall 54. An upper end 80 along a circumference of the outer wall 52 is open. The double walled basket design advantageously enables the basket 50 to be charged with a solvent or washing liquid for enhanced cleaning of the sorbent articles. As will be appreciated, as the basket 50 starts to spin, centrifugal forces cause liquids to pass through the foraminous sidewalls of the basket 50 into the annular area between the basket 50 and the solid outer wall 52 so that the fluid as shown by the arrows L flows over the opened upper end 80 of solid wall 52 and into an annular space 82 between the outer wall 52 and the housing 40. Handles or lifting lugs 84 may be provided on the outer surface of the solid wall 52 to aid in removing the basket 50 from the housing 40.

To facilitate removal of oily fluids from the sorbent articles 14, it is desirable to introduce heat, a wash/rinse solution and/or air into the centrifuge 12. For example, a conduit 86 in flow communication with a source of a rinse/wash solution 88, such as water, may extend through the lid 42 for introducing a pressurized spray 90 of the rinse solution into the basket 50 for rinsing of the sorbent articles 14. Suitable rinse/wash solutions include but are not limited to, detergent solutions, solvents and water.

Accordingly, the centrifuge 12 may be charged with a washing/rinse liquid for enhanced cleaning of the sorbent articles 14 after removal of a bulk of the oily fluid from the pads by action of the centrifuge alone. If subsequently charged with such a solution, it may be desirable to agitate the solution and sorbent articles 14 to release solids and particulates from the articles 14. Accordingly, there may be provided a conduit 92 in flow communication with a source of pressurized gas 94, such as air, which extends centrally through the lid 42 to introduce a stream of gas bubbles 96 into the centrifuge 12 for agitating the sorbent articles 14. For a centrifuge having a diameter of from about 20 to about 30 inches (i.e. from about 15 to about 49 gallons capacity), the spray may be introduced at a rate of from about 5 to about 10 gallons/min for a period of from about 3 to about 5 minutes, and the gas stream may be introduced at a rate of from about 30 to about 50 cubic feet per minute (cfm) for a period of from about 3 to about 5 minutes.

If desired, the gas introduced via the conduit 92 may be heated to a temperature of from about 30 to about 50° C. as by in-line heater 98 to raise the temperature of any liquid in the centrifuge 12 and/or to heat the sorbent articles 14 in order to decrease the viscosity of the oily fluids and thereby facilitate separation of the fluids from the sorbent articles 14. Cooling gas may also be introduced into the centrifuge via conduit 92 to cool the liquids and/or pads after treating the pads to remove organic fluids therefrom.

As will be appreciated, the centrifuge 12 enables removal of fluids from the sorbent articles 14 so that the articles 14 may be reused to collect more oily fluids. As shown in FIG. 2, the sorbent articles 14 may be provided in a variety of shapes and may be made from a variety of hydrophobic materials including, but not limited to, polyolefins, polyurethanes, and the like. Suitable sorbent articles 14 may include those articles described in the following U.S. Pat. Nos.: 5,227,072; 5,229,006; 5,407,575; and 5,403,478, which are incorporated herein by reference as if fully set forth. Other sorbent articles 14 may include those sorbent articles sold under the trade name VISCOUS pom-poms from Seacor Environmental Products, LLC of Seattle, Wash., and OPFLEX FROM Cellect LLC of West Hyannisport, Mass.

Such sorbent articles 14 are substantially hydrophobic and/or lipophilic and thus absorb organic fluids and organic emulsions to the substantial exclusion of aqueous fluids. The sorbent articles 14 may have an organic fluid absorption capacity, based on the weight of organic fluid per weight of sorbent article 14, ranging from about 10 to about 25 times the weight of the sorbent articles 14. Higher or lower capacity sorbent articles 14 may also be used with the system 10 as described herein.

The sorbent articles 14 may be disposed at a spill site or may be distributed in chain-like fashion around an oil source on the waterways or may be floated off-shore along the wetlands areas to remove the oil from the waterways and wetlands. The sorbent articles 14 may also be disposed on the shore or in marshy areas for adsorption of oil from such areas.

A power distribution unit 64 and control box 66 are associated with the drive unit 60 for providing electrical power to the drive unit 60 and for controlling operation of the centrifuge 12. Electrical signals from the control box 66 may be sent to the control panel 38 (FIG. 1) for coordination with other components of the system 10. The centrifuge 12 may be mounted on a skid 68 by fasteners such as bolts 70, which in turn may be separately fastened to the base 32, or the centrifuge 12 may be directly mounted to the base 32. The skid 68 may enable substitution of different size centrifuges 12 for the system depending on the volume of sorbent articles 14 to be treated.

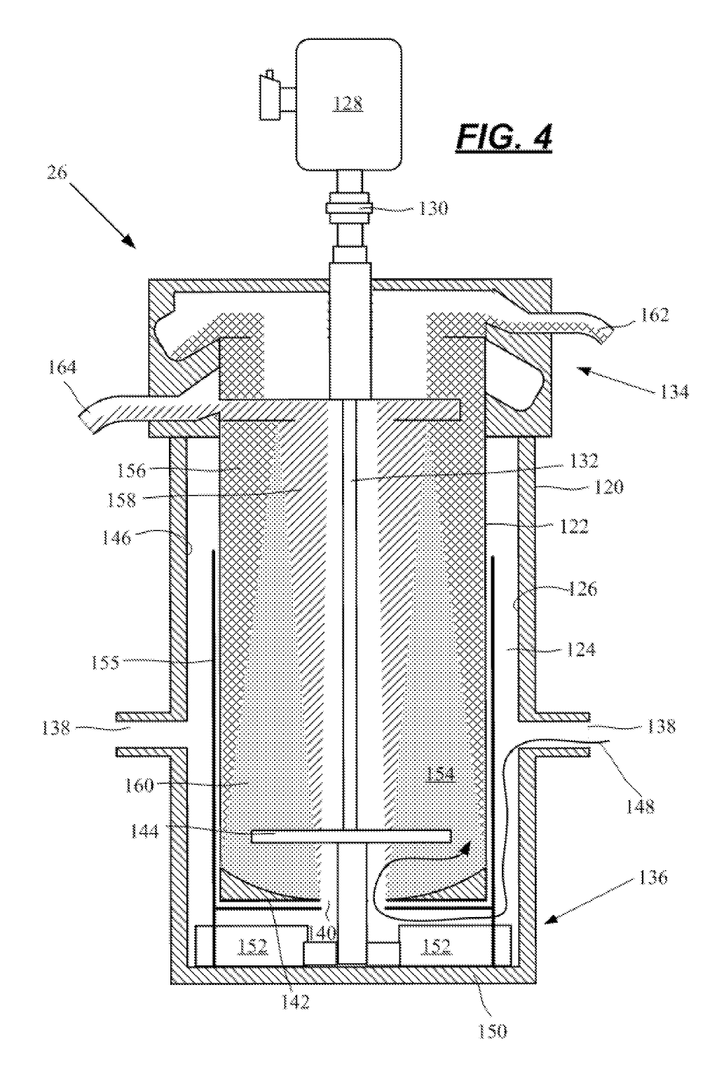

The tank 22 is provided for recovering fluids removed from the sorbent articles 14 during operation of the centrifuge 12. The tank 22 may also be mounted to the skid 68 or directly to the base 32, such as by bolts 72 and L-shaped supports 76. During operation of the centrifuge, 12, the tank 22 is in flow communication with the housing 40 as by conduit 76. An outlet 78 of the tank 22 may be directed or pumped to the centrifugal separator 26 (FIGS. 1 and 4) as by conduit 100 for the essentially continuous separation of oil from water from the fluids collected in the tank 22 by operation of the centrifuge 12.

A typical cleaning cycle for the centrifuge 12 may include the following steps. Sorbent articles 14 are collected from a spill or clean-up site and loaded into the basket 50 of centrifuge 12. After loading the articles 14 into the basket 50, a flow of air from source 94 is heated by in-line heater 98 to a temperature in the range of from about 30 to about 50° C. The flow of hot air is discontinued is and the centrifuge is operated for from about 5 to about 7 minutes at about 1750 rpm to remove the bulk of the oily fluid L which flows by gravity through conduit 76 into tank 22.

Once the flow of fluid has ceased, a rinse liquid from source 88 is sprayed into the centrifuge 12 through conduit 86. During the spraying step, it may be desirable to operate the centrifuge 12 to remove the sprayed liquid either to the same tank 22 or to a separate water recovery tank. Spraying of the articles 14 may be conducted from about 3 to about 5 minutes.

At the end of the spraying cycle, or in lieu of the spraying cycle, the centrifuge 12 may be filled with a cleaning or rinse liquid that may contain a suitable detergent or surfactant including, but not limited to, an anionic surfactant such as sulphonated alkylbenzene, carboxylate, acylated protein hydrolysate, sulfonate, sulfate, phosphate ester and the like, a non-ionic surfactant such as ethoxylate, carboxylic acid ester, carboxylic amide, polyalkylene oxide block copolymer and the like or a cationic surfactant such as quarternary ammonium salt, amines and imidazoline for removing particulates and dust from the articles 14.

In addition to or in lieu of the use of a detergent and/or surfactant for cleaning the articles 14, various biological cleaners may also be used. Such biological cleaners are particularly useful for removing residual hydrocarbon sludges and solids from the articles after removing the bulk of oily fluids from the articles 14. A suitable biological cleaner is a detergent containing polyethylene glycol p-tert-octylphenyl ether such as the product available from Premium Supply Company, Inc. of El Campo, Tex. under the tradename BUGS & SUDS NEUTRAL SURFACE.

In the case of a centrifuge 12 containing only the foraminous basket 50 and not the solid wall 52, conduit 76 or tank 22 may be equipped with a valve to maintain the fluid in the basket 50. Once the basket 50 is filled with fluid, the articles 14 and fluid may be agitated as by the introduction of air from air source 94 through conduit 92 into the centrifuge basket 50. The agitation may be conducted from about 3 to about 5 minutes.

After soaking the articles 14 in a rinse fluid, the articles 14 may be spun dry as by rotating the centrifuge basket 50 at a speed of about 1750 rpm. Because solid bottom 54 is substantially more massive than the walls 52 and basket 50 and because the bottom 54 rotates below the pivot point on shaft 58, any unbalance caused by maldistribution of articles 14 in the basket 50 may be compensated for in a manner similar to the operation of a gyroscope. Accordingly, no special foundations are typically required for mounting the centrifuge 12 and the portability of the centrifuge 12 is enhanced.

As illustrated in FIG. 3, the skid 68 may be configured to accommodate the centrifuge 12, tank 22, power source 66, control unit 64, conduits 86 and 92, rinse solution source 88 and air source 94 so that a completely self-contained centrifuge system is provided. However, one or more of the components described above may be separately, mounted on adjacent skids for easier handling and operation of the centrifuge component of the system 10.

Referring again to FIG. 1, the centrifuge 12 may also include a fume hood 18 and a fume collection system 20. The fume hood 18 having an open bottom 102 may be disposed over an upper portion 104 of the centrifuge 12. The fume hood 18 is configured to collect volatile gases escaping from the centrifuge 12 in an amount sufficient to clean the air emissions from the centrifuge system 12 so as to qualify for air permit exemptions according to State and Federal regulations. The fume hood 18 may also collect fugitive emissions from the fluid collection tank 22.

A blower or vacuum pump 106 may be provided in gas flow communication with the fume hood 18 through conduits 107 and 108 to cause contaminated air to move through an optional condenser 110 for condensing any condensable components from the collected fumes. The vacuum pump or blower 106 is connected by means of an exhaust conduit 112 to an activated carbon absorption unit 114. Cleaned gas is discharged from the carbon absorption unit 114 by means of vent stack 116. The blower 106 may be sized to move at least 400 standard cubic feet per minute (scfm) up to about 2000 scfm through the fume hood 18, conduits 107 and 108 and carbon absorption unit 114. The carbon absorption unit 114 may include one 55 gallon drum of activated carbon per 100 scfm of air discharged from blower 106. Suitable activated carbon for the carbon absorption unit 114 may be selected from activated carbon that is effective to remove organic materials from the gas stream discharged through stack 116 down to an undetectible level, for example, less than about 0.1 parts per million (ppm).

Condensable components of the air and gas stream collected by fume hood 18 are may be condensed in the optional chilled water or cryogenic fluid condenser 110 and the liquid components from the condenser 110 flow into the collection tank 22.

Referring to FIGS. 1 and 4 details of the centrifugal separator unit 26 will now be described. The centrifugal separator unit 26 is specifically designed to separate fluids from one another based on the density of the fluids. The primary components of the centrifugal separator unit 26 include a stationary housing 120, a rotor 122 rotatingly disposed in the housing 120 providing an annular gap 124 between the rotor 122 and a wall 126 of the housing 120. A drive 128, such as an electric motor, is connected through a flexible coupling 130 to a hollow shaft 132. The rotor 122 is attached to the shaft 132 and extends from an upper portion 134 of the housing 120 to a lower portion 136 of the housing 120.

One or more inlets 138 (FIG. 1) are provided in the housing 120 for flow of mixed fluids into the gap 124 between the rotor 120 and the wall 126 of the housing 120. By “mixed fluids” is meant fluids having a difference in density and fluids that are substantially insoluble in one another. The greater the difference in density of the mixed fluids, the better the separation of the fluids from one another. In one embodiment, the separator unit 26 is configured for the separation of oil and water from one another.

As the mixed fluids flow into the separator 26, the fluid flows from the annular gap 124 through an annular opening 140 in a bottom plate 142 of the rotor 122. A diverter structure 144 may be provided on the shaft 132 to divert fluid entering the rotor toward sidewalls 146 of the rotor 122. As shown in FIG. 4 by arrow 148, a mixed fluid entering the separator 26 through inlets 138 toward a bottom plate 150 of the housing 120. The bottom plate 150 may contain vanes 152 for reducing a vortex of fluid adjacent the bottom plate 150 so that fluid flows into a separation zone 154 of the rotor. A stationary baffle 155 may be disposed in the separator 26 between the rotor 122 and the housing 120 to reduce shearing and mixing of fluid entering the separator 26 that may be caused by the spinning rotor 122.

As the rotor 122 spins, the fluid in the separation zone 154 of the rotor 122 is caused to separate by specific gravity providing a substantially heavy or relatively high specific gravity fluid zone 156, substantially light or relatively low specific gravity fluid zone 158, and a mixed fluid zone 160 of fluid in between zones 156 and 158. As more fluid is introduced into the separator 26, fluid from relatively heavy fluid zone 156 flows from the rotor 122 into the upper portion 134 of the separator 26 and flows out of outlet 162 to the polishing unit 30 (FIG. 1). Fluid from the relatively light fluid zone 158 flows from the separation zone 154 into the upper portion 134 of the separator 26 and flows out of outlet 164. In the case of the mixed fluid being an oil/water mixture, the fluid flowing out of outlet 162 is substantially oil-free water and the fluid flowing out of outlet 164 is substantially water free oil.

A typical separator 26 may be sized to handle from about 1 to 200 gallons per minute (3.8 to 750 liters per minute) and provide a G-force at the wall 146 of the rotor of 1400 G's at about 2000 rpm to about 1800 G's at about 8,000 rpm. Residence time of fluid in the separator 26 may range from 15 seconds at 200 gallons per minute to more than 90 seconds at less than 25 gallons per minute depending on the diameter and size of the separator 26.

The separation performance may be determined by the effluent quality of one or both of the fluids from outlets 162 and 164. There are several parameters that determine the fluid output quality. Such parameters include viscosity and density of the fluids in zones 156 and 158 (at the operating temperature), the total flow rate of fluid into the separator 26, and the rotor speed (RPM).

How efficiently fluids from zones 156 and 158 separate in a separator 26 may best be described by Stokes Law as follows:

$${V}_{c} = \frac{{d}^{2} ( {ρ}_{H} - {ρ}_{L} )}{18 {η}_{avg}} \cdot r {ω}^{2}$$

where: V_{c}=the centrifugal settling velocity

d=liquid droplet diameter

rH=density of heavy phase

rL=density of light phase

r=radial distance of liquid from rotor axis

w=angular velocity (RPM of rotor)

havg=average viscosity of processed fluids.

The settling velocity, V_{c}, is an important parameter in phase separation, as it is a measure of how rapidly two immiscible phases will separate from one another.

From the foregoing equation, the parameters that will result in the most efficient phase separation (largest V_{c}) may be evaluated. Parameters that may increase V_{c} include: larger droplet size, increasing the density difference between two phases, high RPM, and low viscosity. The converse is also true—less efficient phase separation may be observed in systems with: smaller droplet size, small density differences, low RPM, and viscous fluids. One parameter that may be used to readily control separation efficiency is the RPM of the rotor 122. Another parameter that may be used to increase separation efficiency is the fluid residence time while in the rotor 122, which is directly controlled by fluid flow rate to the separator through inlet 138. Lowering the feed rate may improve the quality of both separated phases by allowing more residence time of fluid in the separator 26.

Although higher rpm's of the rotor 122 may result in higher g-forces inside the rotor 122, such higher rpm's may result in more mixing in the gap 124 between the rotor 122 and the housing 120, resulting in a smaller droplet size (d). As a result, an increase in rpm's may result in little or no improvement to separation efficiency (V_{c} does not increase), as the increased angular momentum (w) may be offset by a decreasing droplet size (d). Accordingly, inserting the baffle 155 may be useful for decreasing mixing of fluid in the gap 124. The baffle 155 may be particularly useful for separating oil and water from one another.

As with the centrifuge, all of the wetted surface of the separator may be made of a corrosion resistant material such as stainless-steel, titanium, nickel alloys, and the like.

Oil flowing out of outlet 164 may be collected in collection tank 28 for pumping to a barge or other storage facility. The water flowing from outlet 162 may be further treated to remove any traces of organic material, oil, and the like therefrom using polishing unit 30 which may contain activated carbon, oil/water separation membranes, and/or hydrocarbon removal bag filters for providing substantially oil-free water for return from outlet 166 to the waterways or wetlands. A particularly suitable polishing unit 30 may be a bag filtration unit available from Mycelx Technologies Corporation of Gainsville, Ga. Such bag filtration unit may comprise a polypropylene bag material that is impregnated with an oil absorbent composition such as compositions disclosed in U.S. Pat. Nos. 5,437,793; and 5,698,139 that may include thermal reaction products of methacrylate polymers with a glyceride derived from a variety of natural animal and vegetable oils, or the thermal reaction products of methacrylate polymers with a fatty acid or alkene or alkyne containing from about 8-24 carbon atoms. A particularly suitable oil absorbent composition for impregnating the bag filter may be synthesized from an isobutyl methacrylate polymer, and a natural oil, such as linseed oil or sunflower oil. The methacrylate component of the polymer may be derived from methyl methacrylate, ethyl methacrylate, isobutyl methacrylate, or n-butyl methacrylate, or may be a copolymer containing a methacrylate polymer. Suitably, the methacrylate polymer is a poly(isobutyl methacrylate) polymer or a methacrylate/methacrylic acid copolymer.

The water discharged from the bag filter described above may contain less than 1000 ppm oil, typically less than 500 ppm oil and desirably less than 50 ppm oil. In an alternative embodiment, the water discharged from the polishing unit 30 may be collected from outlet 166 and stored for further treatment or use.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. An integrated system for the collection of oil/water compositions and for the separation of water and oil from one another, the system comprising:
a plurality of polymeric sorbent articles for collection of oil/water compositions from waterways or wetlands;
a centrifuge treatment system including a centrifuge having a housing, a housing cover and a rotatable basket received within an interior portion of the centrifuge defined by the housing and cover, the rotatable basket being configured for receiving the plurality polymer sorbent articles containing oil/water compositions for removal of oil/water compositions therefrom by rotation of the basket at a speed sufficient to apply extractive forces to the sorbent articles so that fluids extracted from the sorbent articles travel from the basket into an annular area between the basket and the housing;
a collection tank in flow communication with the annular area for receiving fluids extracted from the sorbent materials;
a centrifugal oil/water separation unit having a oil/water composition inlet, an oil outlet and a water outlet, the inlet being in flow communication with the collection tank for essentially continuous separation of oil and water from one another with an efficiency of at least 97%; and
optionally, a polishing unit in flow communication with the water outlet for treatment of the water to provide substantially hydrocarbon free water.

2. The system of claim 1, wherein the centrifuge system further comprises a fume collection system having a fume hood, wherein the centrifuge is disposed in the fume hood of the fume collection system.

3. The system of claim 2, further comprising a condenser in flow communication with the fume hood and the collection tank for removing condensable components from the fume collection system and collection tank.

4. The system of claim 1, wherein each of the sorbent articles comprises a bundle of oleophilic fibers.

5. The system of claim 1, wherein the sorbent articles comprise liphophilic mats.

6. The system of claim 1, wherein the polishing unit is selected from the group consisting of an activated carbon filtration unit, a polymeric filtration unit, and the like.

7. The system of claim 1, wherein the centrifuge of the centrifuge treatment system comprises a self-balancing centrifuge.

8. The system of claim 1, wherein the system is mounted on a vehicle for transport to a remote site.

9. The system of claim 8, further comprising a wheeled cart releasably mountable on a vehicle, wherein the system is fixedly mounted to a wheeled cart.

10. A method for recovering oil from an oil spill or leak into waterways or wetlands comprising:
disposing a plurality of polymeric sorbent articles for collection of oil/water compositions from the waterways or wetlands;
centrifuging the polymeric sorbent articles containing an oil/water composition in a centrifuge treatment system that comprises a centrifuge having a housing, a housing cover and a rotatable basket received within an interior portion of the centrifuge defined by the housing and cover, the rotatable basket being configured for receiving the plurality polymer sorbent articles containing the oil/water composition for removal of the oil/water composition therefrom by rotation of the basket at a speed sufficient to apply extractive forces to the sorbent articles so that fluids extracted from the sorbent articles travel from the basket into an annular area between the basket and the housing;
collecting the fluids extracted from the sorbent articles in a collection tank in flow communication with the annular area of the centrifuge;
flowing the fluids from the collection tank into a centrifugal oil/water separation unit having a fluid inlet, an oil outlet and a water outlet, the inlet being in flow communication with the collection tank for essentially continuously separating water and oil from one another with an efficiency of at least 97%; and
optionally, flowing the separated water into a polishing unit in flow communication with the water outlet of the centrifugal oil/water separator for treatment of the water to provide substantially hydrocarbon free water.

11. The method of claim 10, wherein the centrifuge system comprises a fume collection system having a fume hood, wherein the centrifuge is disposed in the fume hood of the fume collection system for collecting and disposing fumes during the centrifuging step.

12. The method of claim 11, further comprising condensing condensable components of the fumes in a condenser in flow communication with the fume hood and the collection tank.

13. The method of claim 10, wherein each of the sorbent articles comprises a bundle of oleophilic fibers.

14. The method of claim 10, wherein the sorbent articles comprise liphophilic mats.

15. The method of claim 10, wherein the polishing unit is selected from the group consisting of an activated carbon filtration unit, a polymeric filtration unit, and the like.

16. The method of claim 10, wherein the centrifuge of the centrifuge treatment system comprises a self-balancing centrifuge.

17. The method of claim 10, wherein the centrifuge treatment system, collection tank, centrifugal oil/water separation unit, and optional polishing unit are mounted on a vehicle for transport to a remote site.
